(19) United States
(12) Patent Application Publication
(10) Pub. No.: US 2016/0049211 A1
(43) Pub. Date: Feb. 18, 2016

(54) SILICON CARBIDE MULTILAYERED CLADDING AND NUCLEAR REACTOR FUEL ELEMENT FOR USE IN WATER-COOLED NUCLEAR POWER REACTORS

(71) Applicant: Ceramic Tubular Products, LLC, Rockville, MD (US)

(72) Inventors: Herbert Feinroth, Silver Spring, MD (US); Matthew W. Ales, Forest, VA (US); Gregory T. Markham, Bedford, VA (US)

(73) Assignee: Ceramic Tubular Products, LLC, Rockville, MD (US)

(21) Appl. No.: 14/012,242

(22) Filed: Aug. 28, 2013

Related U.S. Application Data
(60) Provisional application No. 61/740,102, filed on Dec. 20, 2012.

(51) Int. Cl. G21C 3/07

(52) U.S. Cl. CPC G21C 3/07

(57) ABSTRACT

A nuclear fuel element for use in water-cooled nuclear power reactors and an improved multilayered silicon carbide tube for use in water-cooled nuclear power reactors and other high temperature, high strength thermal tubing applications including solar energy collectors. The fuel element includes a multilayered silicon carbide cladding tube. The multilayered silicon carbide cladding tube includes (i) an inner layer; (ii) a central layer; and (iii) a crack propagation prevention layer between the inner layer and the central layer. A stack of individual fissionable fuel pellets may be located within the cladding tube. In addition, a thermally conductive layer may be deposited within the cladding tube between the inner layer of the cladding tube and the stack of fuel pellets. The multilayered silicon carbide cladding tube may also be adapted for other high temperature, high strength thermal tubing applications including solar energy collectors.

### CROSS-REFERENCE TO RELATED APPLICATIONS

This application is related to PCT Application No. 12/42981, filed Jun. 19, 2012, the contents of which are hereby incorporated by reference in its entirety. This application claims the benefit of Provisional Application Ser. No. 61/740,102 filed Dec. 12, 2012.

### STATEMENT AS TO RIGHTS TO INVENTIONS MADE UNDER FEDERALLY SPONSORED RESEARCH OR DEVELOPMENT

Work described herein may have been supported in part by Department of Energy (DOE) Grant No. DE-SC0004225. The United States Government may therefore have certain rights in the inventions.

### BACKGROUND

1. Field

The present inventions relate generally to nuclear fuel elements for use in water-cooled nuclear power reactors and, more particularly, to an improved multilayered silicon carbide cladding tube including a crack propagation prevention layer, which may be adapted to receive a stack of a variety of individual fissionable fuel pellets or may also be adapted for other high temperature, high strength thermal tubing applications including solar energy collectors.

2. Related Art

Nuclear fuel elements are designed to produce fission heat in a nuclear power reactor. Fuel elements are sealed fuel rods containing stacks of ceramic pellets containing fissile material with these being clad and sealed usually in zirconium alloy tubes. A multiplicity of these individual fuel elements are first assembled into a fuel assembly that is inserted into the nuclear reactor pressure vessel and then used with other fuel assemblies for generating fission heat to drive a turbine to make electricity.

For several years there has been research on possible replacement of the zirconium alloy (zircaloy) cladding with a multilayer silicon carbide cladding that has greater hardness, corrosion resistance and strength than zircaloy at high temperatures (above 500° C.), and better neutron transparency & moderation effect.

Multilayer silicon carbide cladding has been shown experimentally to be more resistant to damage during postulated reactor accidents, partly because it does not react violently and exothermically with water and release hydrogen, as does the zircaloy clad during Loss of Coolant Accidents, such as occurred at Three Mile Island in 1979, and Fukushima in 2011.

Such multilayer cladding is described in the following patent applications: U.S. patent application Ser. No. 12/229,299, filed Aug. 21, 2008 to Feinroth et al. discloses a multilayered ceramic tube for fuel containment barrier and other applications in nuclear and fossil power plants. The disclosure of this patent application and its cited references is hereby incorporated by reference in its entirety.

U.S. patent application Ser. No. 11/144,786 filed Jun. 6, 2005 to Feinroth et al. discloses a ceramic tube for fuel containment barrier and other applications in nuclear and fossil power plants. The disclosure of this patent application and its cited references is hereby incorporated by reference in its entirety.

U.S. Provisional Patent Application Ser. No. 60/577,209 filed Jun. 7, 2004 to Feinroth et al. discloses a ceramic tube for fuel containment barrier and other applications in nuclear and fossil power plants. The disclosure of this patent application and its cited references is hereby incorporated by reference in its entirety.

However, because the silicon carbide clad has a ceramic structure that is not susceptible to mechanical creep during operation, its behavior when operating with uranium oxide fuel leaves an insulating gap between the cladding and the uranium oxide fuel, leading to higher fuel temperatures and eventually to more fission gas release during long-term operation. Zircaloy cladding, on the other hand, creeps down onto the surface of the fuel pellets during the early months of operation, eliminating the insulating gap between fuel and cladding.

The higher fuel centerline temperatures with silicon carbide cladding as compared to zircaloy cladding, may lead to reduced margin to fuel element melting during nuclear power plant transients, which reduces the safety margin.

Several approaches have been considered to counteract the effect of this insulating gap and thereby allow the silicon carbide clad fuel to operate at acceptable fuel temperatures required for long term operation and for accident tolerance. The PCT Application No. 12/42981, filed Jun. 19, 2012 is an example of such an approach in which the fissile fuel pellets are made of more temperature resistant materials such as thoria plutonia fuel, having higher thermal conductivity and higher melting temperatures than the usual uranium oxide fuel. Another approach that would help reduce the fuel temperature of a silicon carbide clad fuel element with uranium dioxide fuel pellets, is to provide a thermally conducting layer of material on the inside of the cladding to help transmit the heat from the fuel pellet through the cladding to the outside coolant.

Thus, there remains a need for a new and improved nuclear fuel element for use in water-cooled nuclear power reactors which includes an improved multilayered silicon carbide cladding tube while, at the same time, includes a crack propagation prevention layer between the inner layer and the central layer, which may be adapted to receive a stack of a variety of individual fissionable fuel pellets or may also be adapted for other high temperature thermal tubing applications including solar energy collectors.

### SUMMARY

The present inventions are directed to a nuclear fuel element for use in water-cooled nuclear power reactors and to an improved multilayered silicon carbide tube for use in water-cooled nuclear power reactors and other high temperature, high strength thermal tubing applications including solar energy collectors. The fuel element includes a multilayered silicon carbide cladding tube. The multilayered silicon carbide cladding tube includes (i) an inner layer; (ii) a central layer; and (iii) a crack propagation prevention layer between the inner layer and the central layer. A stack of individual fissionable fuel pellets may be located within the cladding tube. In addition, a thermally conductive layer may be deposited within the cladding tube between the inner layer of the cladding tube and the stack of fuel pellets.

The inner layer of the multilayered silicon carbide cladding tube may be a monolith layer. In one embodiment, the inner monolith layer is formed by chemical vapor deposition.

The crack propagation prevention layer of the multilayered silicon carbide cladding tube may be pyrolytic carbon. In one embodiment, the crack propagation prevention layer is formed of pyrolytic carbon between about 10 and about 50 microns in thickness.

The central layer of the multilayered silicon carbide cladding tube may be a composite of silicon carbide surrounded by a silicon carbide matrix. The central composite layer may include silicon carbide fibers. In one embodiment, the silicon carbide fibers are in the form of a tow or a ribbon that includes between about 500 and about 1600 fibers having between about 8 and about 14 microns in diameter. Also, in one embodiment, the silicon carbide fibers include a carbon interface coating thickness of between about 0.1 and about 1 micron.

The cladding tube may further include an outer monolith layer for reducing corrosion during reactor operation. In one embodiment, the outer monolith layer is high density silicon carbide formed by a process selected from the group consisting of chemical vapor infiltration and chemical vapor deposition. Also, the outer monolith layer may have a thickness between about 3 and about 10 mils.

The multilayer silicon carbide cladding tube may be substantially formed of stoichiometric beta silicon carbide crystals that are resistant to damage by neutron radiation.

The cladding tube may further include hermetically sealed end caps. In one embodiment, the end caps are formed of high density silicon carbide. The end caps may be substantially formed of stoichiometric beta silicon carbide crystals that are resistant to damage by neutron radiation. Also, the end caps may be diffusion bonded to the multilayer silicon carbide cladding tube.

The multilayer silicon carbide cladding tube may be between about 1.5 and about 14 feet in length, with a tube wall thickness between about 20 and about 50 mils and with a tube outside diameter between about 0.25 and about 0.5 inches.

The fuel element may further include a stack of individual fissionable fuel pellets. The fuel pellets may include thorium oxide, plutonium oxide, uranium oxide, americium oxide, neptunium oxide, curium oxide and mixtures thereof. In one embodiment, the fuel pellets are a mixture of thorium oxide and plutonium oxide. Preferably, the fuel pellets include between about 1 wt. % and about 20 wt. % plutonium oxide and the balance thorium oxide. Also, the fuel pellets may further include uranium 233 oxide substituted for the plutonium oxide and mixtures thereof.

The fuel pellets in the fuel element are sized to be received within the cladding tube adjacent to the thermally conductive layer deposited with the cladding tube.

In one embodiment, the thermally conductive layer deposited within the cladding tube is colloidal carbon. The thermally conductive layer deposited within the cladding tube may be between about 3 and 50 microns.

Accordingly, one aspect of the present inventions is to provide a nuclear fuel element for use in water-cooled nuclear power reactors, the fuel element including (a) a multilayered silicon carbide cladding tube; and (b) a thermally conductive layer deposited within the cladding tube.

Another aspect of the present inventions is to provide in an improved multilayered silicon carbide tube for use in water-cooled nuclear power reactors and other high temperature, high strength thermal tubing applications including solar energy collectors, the improvement including (a) a multilayered silicon carbide tube, the multilayered silicon carbide tube including (i) an inner layer and (ii) a central layer; and (b) a crack propagation prevention layer between the inner layer and the central layer.

Still another aspect of the present inventions is to provide a nuclear fuel element for use in water-cooled nuclear power reactors, the fuel element including (a) a multilayered silicon carbide cladding tube, the multilayered silicon carbide cladding tube including (i) an inner layer; (ii) a central layer; and (iii) a crack propagation prevention layer between the inner layer and the central layer; (b) a stack of individual fissionable fuel pellets located within the cladding tube; and (c) a thermally conductive layer deposited within the cladding tube between the inner layer of the cladding tube and the stack of fuel pellets.

These and other aspects of the present inventions will become apparent to those skilled in the art after a reading of the following description of the preferred embodiment when considered with the drawings.

### BRIEF DESCRIPTION OF THE DRAWINGS

FIG. 1 is a longitudinal, cross-sectional view of a nuclear reactor fuel element having silicon carbide cladding and a variety of fissionable fuels constructed according to the present inventions;

FIG. 2 is a radial, cross-sectional view of the nuclear reactor fuel element having silicon carbide cladding and a variety of fissionable fuels shown in FIG. 1 taken along lines 2-2;

FIG. 3 is an enlarged, radial, cross-sectional view of the nuclear reactor fuel element having silicon carbide cladding and a variety of fissionable fuels shown in FIG. 2; and

FIG. 4 is a graph illustrating Maximum Centerline Fuel Temperature for Zircaloy and SiC clad fuel rods.

### DESCRIPTION OF THE EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

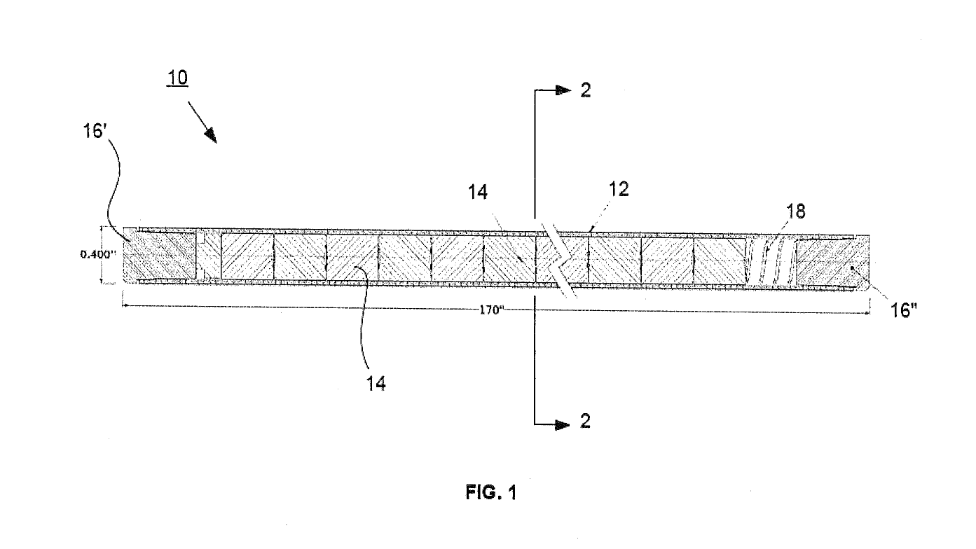

Referring now to the drawings in general and FIG. 1 in particular, it will be understood that the illustrations are for the purpose of describing a preferred embodiment of the inventions and are not intended to limit the inventions thereto. As best seen in FIG. 1, a nuclear fuel element, generally designated 10, is shown constructed according to the present inventions. FIG. 1 is a longitudinal, cross-sectional view of the SiC clad fissionable fuel element that is the subject of the present inventions.

As shown in FIG. 1, the fuel element 10 is a tubular structure, generally about 170 inches long and 0.4 inches diameter. Variations exist for different types of water reactors, where the length can be as short as 18 inches, and the diameter can be as large as about 0.5 inches. The fuel element 10 includes the following parts as shown on FIG. 1:

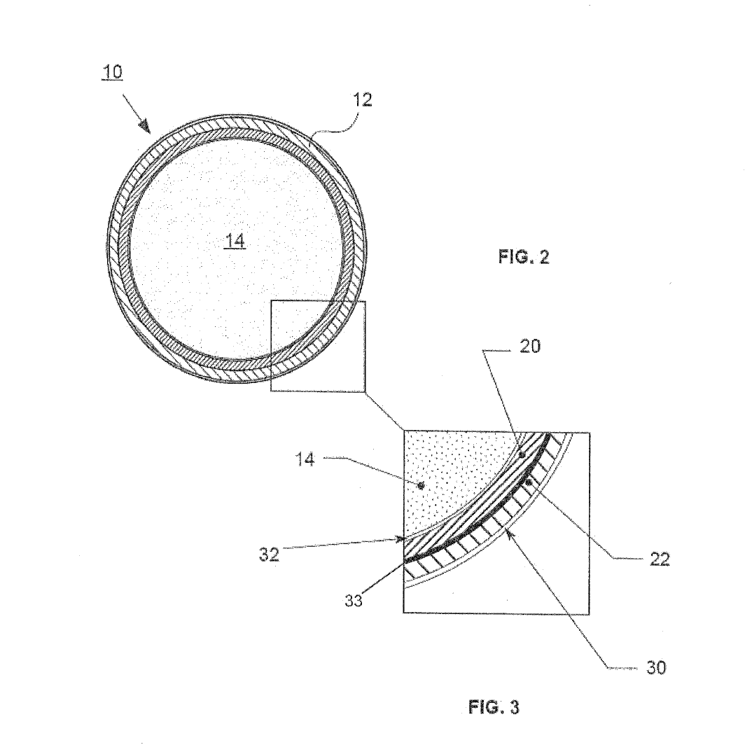

Part A. Fuel Pellets—About 440 sintered thoria-plutonia pellets 14 of high density (95% of theoretical density) axially stacked within the tube 12, and containing from 5% to 20% by weight of plutonium oxide, and 80% to 95% of thorium oxide. In a typical case, the pellets 14 are about 0.350″ in diameter and about 0.350″ long, Variations exist where the number of pellets 14 can be as few as 40 per fuel element 10, and with diameters and lengths as high as 0.5 inches
Part B. End Plugs—Two end plugs 16′, 16″ also made from dense silicon carbide, one at each end of the tube 12, and sealed to the tube 12 to contain fission gases that are released from the fuel pellets 14 during irradiation. Each end plug is about 0.4 inches in diameter and 1 to 1.5 inches long
Part C. Multilayered. Silicon Carbide Tube—A hollow three-layered SiC cladding tube 12 that is 170 inches long, 0.356 inches inside diameter, 0.035 inches in thickness, and 0.426 inches outside diameter. The makeup of the internal structure of the multilayered cladding tube 12 is presented in FIG. 2.
Part D. Plenum Spring—A helical spring 18, about 0.035 inches in outside diameter, and about 15 inches long, inserted into one end of the Part C cladding tube 12 to retain the fuel pellets 14 in place during loading and handling. The spring 18 is generally made of Inconel® metal alloys. In some applications, the spring 18 is not used and the space is filled with pellets 14.

Turning now to FIG. 2, there is shown a radial, cross-sectional view of the fuel element 10 taken along lines 2-2 showing the makeup of the multilayered cladding 12. The fuel element 10 includes the following parts as shown on FIG. 2:

Part A—is the fissionable fuel pellets 14 also shown in FIG. 1
Part E—is the dense SiC monolith 20, the inside layer of the multilayered tube 12, with density greater than 99% to ensure hermeticity to retain fission gas. It is generally made via a chemical vapor deposition process to ensure high quality and beta phase crystals to minimize irradiation growth. Thickness is about 0.014 inches.
Part F—is the SiC—SiC composite layer 22 designed to provide extra strength and a graceful failure mode of the multilayered tube 12. The SiC composite layer 22 is made of helical wound stoichiometric SiC fibers 24 (not shown but identified for clarity)(about 12 microns in diameter, coated with a layer of carbon 28 (also not shown but identified for clarity) about 0.2 microns in thickness) and infiltrated with a matrix 26 (also not shown but identified for clarity) of vapor deposited SiC using the Chemical Vapor Infiltration process. The thickness of the part F composite layer 22 is about 0.014 inches.
Part G—is the SiC environmental barrier layer 30, which is made of dense SiC deposited via a Chemical Vapor Deposition or a Chemical Vapor Infiltration process, and providing a robust defense against corrosion of the tube 12 during long periods of operation in the reactor coolant water. The thickness of part G is generally about 0.007 inches.
Gap H—is a gas space 32 between the outside of the fissionable pellets 14, Part A, and the inside monolith 20, Part E that is needed to allow assembly of the pellets 14 into the cladding tube 12. Without this gap 32, it would be very difficult to assemble the pellets 14 into the cladding tube 12. However, as previously discussed, the existence of this gap 32 during reactor operation serves as a thermal insulator, causing a higher temperature of the fuel pellets 14 than would otherwise occur without the gap 32.

In one embodiment, the SiC fuel cladding tube 12 shown in FIGS. 1-3 consists of three layers 20, 22 and 30, each with a different primary function.

The inner layer 20 is dense (>99% of theoretical density) pure beta phase stoichiometric silicon carbide monolith made via the chemical vapor deposition process to preserve purity and assure high density. The absence of significant porosity assures that the tube 12 is leak tight, and will contain fission product gases evolved during normal reactor operations including operational transients. In one embodiment, the inner layer 20 is about 0.014 inches thick, about 0.360 inches in outside diameter, and up to 170 inches long. For other applications, it can be as short as 18 inches long (the length of fuel elements in the CANDU heavy water reactors), with diameters ranging from 0.250 inches to 0.500 inches.

The central layer 22 is a ceramic composite consisting of high purity beta phase dense stoichiometric silicon carbide fibers 24 (not shown but identified for clarity), each with a nominal diameter of 10 microns, (ranging from 8 to 14 microns in diameter), formed into a tow consisting of a nominal 1000 fibers, (ranging from 500 to 1500 fibers per tow) with the tow wound in helical fashion around the inner monolith 20. Each fiber 24 is coated with a thin carbon interface coating 28 (also not shown but identified for clarity) of a nominal 0.2 microns in thickness, (ranging from 0.1 microns to 1 micron) and then the tow is wound around the inner monolith layer 20 in helical geometry, creating one or more layers. The spaces between the tows and between the fibers within a tow is infiltrated with beta phase SiC vapor using the chemical vapor infiltration process to create matrix 26 (also not shown but identified for clarity), and a composite that is not brittle and therefore retains a graceful failure mode.

The improved composite behavior of the present inventions is believed to be due to the carbon interface layer 28 allowing the fibers 24 to slip within the matrix 26 when subject to mechanical loading, thus assuring a stress strain behavior similar to metals rather than brittle ceramics. This feature allows the multilayered tube 12 to serve as a robust clad material that retains its geometry and solid fuel containment barrier even during severe operating conditions that could cause the inner monolith to crack and release contained gases.

Although the composite layer 22 provides the needed robustness, it does contain some porosity (10 to 15%) as the matrix infiltration technique does not fill in all the spaces between the fibers 24. Hence it is not hermetic and is not able to contain the fission gases that are released during irradiation for radiation applications. The separate inner layer 20 serves as the primary gas containment vessel.

The composite layer 22 also serves to reinforce the pressure containing capability of the inner monolith, allowing the combination of monolith layer 20 and composite layer 22 to retain internal pressures up to 8000 psi, as compared to pressures of less than 5000 psi that would be contained by the inner monolith 20 alone. The central layer 22 is also about 0.014 inches in thickness, with some variation allowing the thickness to be about 0.022 inches. Length of the preferred application is about 170 inches. Outside diameter is about 0.400 inches.

A limitation of multilayer silicon carbide cladding tubes such as described in PCT Application No. 12/42981, filed Jun. 19, 2012 and U.S. patent application Ser. No. 12/229,299, filed Aug. 21, 2008 to Feinroth et al. is the potential of a crack that develops in the inner monolith layers of the clad tube to propagate into the adjacent layer during a rapid mechanical shock and thereby cause a full circumferential break in the tube. During an early phase of testing of those tubes, it was found that if a crack should develop within the monolith due to accidental high mechanical impact, creating a high strain rate, the crack would proceed into the composite layer, and lead to a premature failure there as well.

In the present inventions, a crack prevention layer 33 may be provided between the inner layer 20 and the central layer 22. The crack prevention layer 33 acts to arrest such a crack initiated within the monolith layer 20 and prevent its propagation into and through the composite layer 22. The crack propagation prevention layer 33 of the multilayered silicon carbide cladding tube may be pyrolytic carbon. In one embodiment, the crack propagation prevention layer 33 is formed of pyrolytic carbon is between about 10 and about 50 microns.

Mechanical shock tests performed on multilayered SiC cladding tubes constructed according to the present inventions show that the energy required to fracture the cladding tube is increased by at least a factor of two when a crack propagation prevention layer is included as compared to the case where there is no crack propagation layer, and in some cases, the energy required was increased by a factor of six. These are a significant and unexpected improvement.

The outer layer 30 is provided as a corrosion barrier, and is a dense (>99% of theoretical) beta phase silicon carbide layer deposited via the chemical vapor deposition method. The thickness of the outer layer 30 is a nominal 0.007 inches, but can range from 0.003 inches to 0.010 inches depending on the application. Tests in the water-cooled loop of the MIT Research Reactor indicate the capability of the outer environmental barrier layer 30 to assure a durability of the cladding tube 12 in typical reactor coolant (300° C.) of at least 8 years.

Preferably, the silicon carbide used in the multilayered cladding tube 12 is high purity stoichiometric beta phase material because extensive tests have shown that other forms of silicon carbide, containing minor impurities and/or alpha phase material do not retain as much strength during irradiation, which would not be as desirable for reactor application.

Recent tests at Ceramic Tubular Products show that replacing zircaloy cladding with SiC ceramic cladding would reduce the amount of heat generated, and the amount of flammable hydrogen generated, during Loss of Coolant Accidents such as occurred at Three Mile Island and Fukushima, by factors of 500 or more, thus reducing accident severity, minimizing release of radioactive fuel, and avoiding the loss of many billions of dollars of investment.

The multilayered silicon carbide cladding tube 12 also has the capability of containing nuclear fuel that is taken to high burnups of over 100 MWd/kg of initial heavy metal as compared to a maximum of about 60 MWd/kg that is achievable for zirconium alloy clad fuel. In addition, because of its high temperature resistance, the SiC multilayered cladding tube 12 has the potential for allowing increased power density, thus improving the economics of nuclear power generation.

Recent evaluation of the predicted behavior of the multilayered cladding in a typical commercial nuclear reactor has identified an important property with regard to long-term integrity. Contrary to metal cladding, the SiC multilayered cladding tube 12 is not expected to creep when subject to mechanical loading. Hence, the gap 32 between the inner cladding layer 20 and the internal fuel pellets 14, generally about 0.003 inches radial clearance to allow assembly, is likely to remain through much of the fuel lifetime. With metal cladding, the gas gap 32 is mitigated during early operation because the reactor pressure causes the cladding to creep down onto the outside of the fuel pellets 14.

The gas gap 32 between pellets 14 and the silicon carbide cladding 12 is expected to act as a thermal insulator, leading to internal fuel temperatures that are up to 400° C. higher than if the fuel were clad with zirconium alloy. When operating at these higher temperatures, traditional uranium oxide fuel is expected to degrade more quickly during reactor operation, leading to more rapid migration and release of fission gases within the sealed clad containment barrier, thus leading to higher internal pressures and shorter fuel life.

The more rapid fission gas release and fission gas pressure buildup within the ceramic clad fuel would be expected to limit the amount of energy, or burnup that would otherwise be achieved with the new clad material, and hence limit its economic potential. The higher fuel temperatures also could reduce the margin to melting during accidental power transients, thus limiting the power rating of the ceramic clad fuel element and this also could limit its economic potential.

Research by Carpenter at the Massachusetts Institute of Technology in 2010 describes the behavior of uranium oxide fuel in a typical commercial PWR when clad with silicon carbide as compared to zircaloy. The Seabrook Nuclear Plant was used as reference core design. A case was analyzed with 1500 days exposure to 70 MWd/kg average burnup for the peak rod, with the average linear heat generation rate of that peak rod at beginning of life of 8.5 kw/ft, and gradually dropping to 4 kw/ft at end of life, typical of operation in a 3 batch PWR reload scenario. A modified version of the computer code FRAPCON SiCv2, described by Carpenter, was used for the analysis.

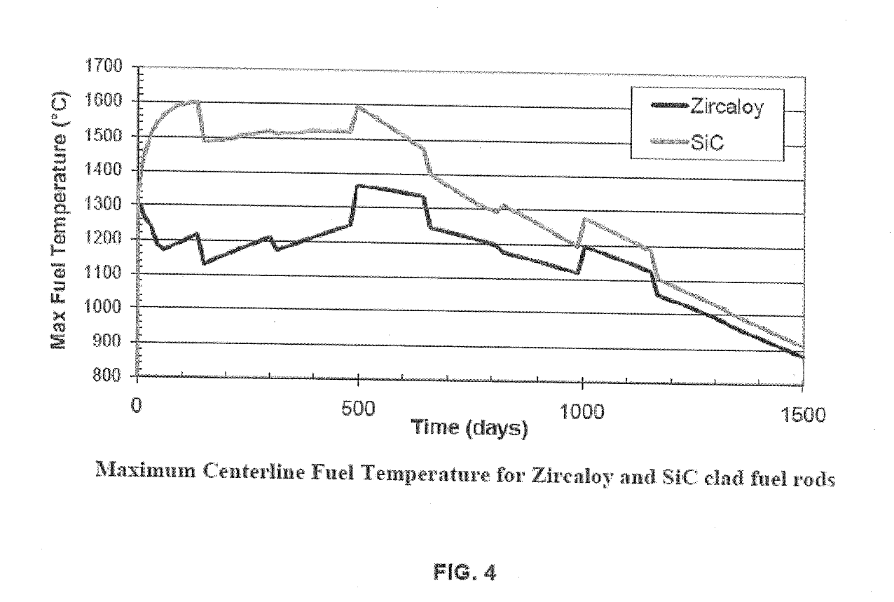

FIG. 4 portrays the results of Carpenter's calculations. Note that the peak fuel temperature of SiC clad conventional Uranium Oxide (UO₂) fuel reaches a maximum of 1600° C. during steady state operation early in life, as compared to about 1200° C. for zircaloy clad conventional UO₂ fuel. In addition to the additional fission gas release, and resulting internal fuel rod pressure resulting from this higher temperature, the margin to melting of the UO₂ fuel (melting temperature of 2800° C.) during accidental transients and accidents is only 1200° C., as compared with about 1600° C. with zircaloy clad. This smaller margin could be used up during design basis transients, leading to centerline melting, an unacceptable condition. Regulations and safe utility operational procedures require that there be sufficient margin to melting during such transients to avoid potential fuel damage and release to coolant.

By providing an additional thermal conducting layer on the inside of the clad tube, the fuel centerline temperature will be reduced thus increasing the margin between peak steady state centerline temperature and fuel melting temperature of a fuel element with SiC cladding.

Further if the thermal conducting layer is made of a lubricating material, such as colloidal graphite, it will facilitate the assembly of the pellets into the clad tube during manufacture, thus reducing the gap size during operation, and thereby further reducing the centerline temperature.

Certain modifications and improvements will occur to those skilled in the art upon a reading of the foregoing description. By way of example, the end caps may be forming of alpha-silicon carbide. For CANDU and other applications, the end caps may be formed of solid refractory metals that readily diffusion bond with SiC. The fiber interface coatings may be of several families of oxide, nitride, pyrolytic, and multilayered coatings. Also, the crack propagation prevention layer of the present inventions may be useful in multilayer silicon carbide tubes in other uses requiring the high temperature strength and corrosion resistance of silicon carbide, including but not limited to high temperature heat exchangers. Finally, the crack propagation layer may be constructed of typical silicon carbide fiber interface coatings from the oxide family: Zirconia (ZrO₂), Yttria-stabilized zirconia (YSZ), Titania (TiO₂), Alumina (Al₂O₃), Hafnia (HfO₂), Yttria (Y₂O₃), Silica (SiO₂), Tantala (Ta₂O₅), monazite[Lanthinum phosphorous oxide] (LaPO₄); the nitride family: Zirconium nitride (ZrN), Hafnium nitride (HfN), Boron Nitride (BN), Silicon-doped BN (Si—BN), Aluminum nitride (AlN), Silicon Nitride (Si₃N₄), Titanium Nitride (TiN); Pyrolytic forms: Pyrolytic Carbon-Boron Carbide (PyC-B₄C), Pyrolytic Boron Nitride-Silicon Carbide (BN—SiC), Pyrolytic Boron Nitride, Pyrolytic Boron Nitride-Silicon (PB(Si)N); the carbide family such as Hafnium Carbide (HfC); or a multilayer combination of these compositions. It should be understood that all such modifications and improvements have been deleted herein for the sake of conciseness and readability but are properly within the scope of the following claims.

We claim:

1. A nuclear fuel element for use in water-cooled nuclear power reactors, said fuel element comprising:
(a) a multilayered silicon carbide cladding tube; and
(b) a thermally conductive layer deposited within said cladding tube.

2. The fuel element according to claim 1 further including a stack of individual fissionable fuel pellets.

3. The fuel element according to claim 2, wherein said fuel pellets include thorium oxide, plutonium oxide, uranium oxide, americium oxide, neptunium oxide, curium oxide and mixtures thereof.

4. The fuel element according to claim 3, wherein said fuel pellets are a mixture of thorium oxide and plutonium oxide.

5. The fuel element according to claim 4, wherein said fuel pellets include between about 1 wt. % and about 20 wt. % plutonium oxide and the balance thorium oxide.

6. The fuel element according to claim 5, wherein said fuel pellets further include uranium 233 oxide substituted for the plutonium oxide and mixtures thereof.

7. The fuel element according to claim 2, wherein said fuel pellets are sized to be received within said cladding tube adjacent to said thermally conductive layer deposited with said cladding tube.

8. The fuel element according to claim 1, wherein said thermally conductive layer deposited within said cladding tube is colloidal carbon.

9. The fuel element according to claim 8, wherein said thermally conductive layer deposited within said cladding tube is between about 3 and about 50 microns.

10. An improved multilayered silicon carbide tube for use in water-cooled nuclear power reactors and other high temperature, high strength, high strength thermal tubing applications including solar energy collectors, the improvement comprising:
(a) a multilayered silicon carbide tube, said multilayered silicon carbide tube including (i) an inner layer and (ii) a central layer; and
(b) a crack propagation prevention layer between said inner layer and said central layer.

11. The tube according to claim 10, wherein said inner layer is a monolith layer.

12. The tube according to claim 11, wherein said inner monolith layer is formed by chemical vapor deposition.

13. The tube according to claim 10, wherein said crack propagation prevention layer is pyrolytic carbon.

14. The tube according to claim 13, wherein said crack propagation prevention layer formed of pyrolytic carbon is between about 10 and about 50 microns.

15. The tube according to claim 10, wherein said central layer is a composite of silicon carbide surrounded by a silicon carbide matrix.

16. The tube according to claim 15, wherein said central composite layer includes silicon carbide fibers.

17. The tube according to claim 16, wherein said silicon carbide fibers are in the form of a tow or a ribbon that includes between about 500 and about 1600 fibers having between about 8 and about 14 microns in diameter.

18. The tube according to claim 17, wherein said silicon carbide fibers include a carbon interface coating thickness of between about 0.1 and about 1 micron.

19. The tube according to claim 10, further including an outer monolith layer for reducing corrosion during reactor operation for reactor applications.

20. The tube according to claim 19, wherein said outer monolith layer is high density silicon carbide formed by a process selected from the group consisting of chemical vapor infiltration and chemical vapor deposition.

21. The tube according to claim 19, wherein said outer monolith layer has a thickness between about 3 and about 10 mils.

22. The tube according to claim 10, wherein said multilayer silicon carbide tube is substantially formed of stoichiometric beta silicon carbide crystals that are resistant to damage by neutron radiation for reactor applications.

23. The tube according to claim 10, further including hermetically sealed end caps.

24. The tube according to claim 23, wherein said end caps are formed of high density silicon carbide.

25. The tube according to claim 24, wherein said end caps are substantially formed of stoichiometric beta silicon carbide crystals that are resistant to damage by neutron radiation for reactor applications.

26. The tube according to claim 23, wherein said end caps are diffusion bonded to said multilayer silicon carbide tube.

27. The tube according to claim 10, wherein said multilayer silicon carbide tube is between about 1.5 and about 14 feet in length, with a tube wall thickness between about 20 and about 50 mils and with a tube outside diameter between about 0.25 and about 0.5 inches for reactor applications.

28. A nuclear fuel element for use in water-cooled nuclear power reactors, said fuel element comprising:
(a) a multilayered silicon carbide cladding tube, said multilayered silicon carbide cladding tube including (i) an inner layer; (ii) a central layer; and (iii) a crack propagation prevention layer between said inner layer and said central layer;
(b) a stack of individual fissionable fuel pellets located within said cladding tube; and
(c) a thermally conductive layer deposited within said cladding tube between said inner layer of said cladding tube and said stack of fuel pellets.

29. The fuel element according to claim 28, wherein said fuel pellets include thorium oxide, plutonium oxide, uranium oxide, americium oxide, neptunium oxide, curium oxide and mixtures thereof.

30. The fuel element according to claim 29, wherein said fuel pellets are a mixture of thorium oxide and plutonium oxide.

31. The fuel element according to claim 30, wherein said fuel pellets include between about 1 wt. % and about 20 wt. % plutonium oxide and the balance thorium oxide.

32. The fuel element according to claim 31, wherein said fuel pellets further include uranium 233 oxide substituted for the plutonium oxide and mixtures thereof.

33. The fuel element according to claim 28, wherein said fuel pellets are sized to be received within said cladding tube adjacent to said thermally conductive layer deposited with said cladding tube.

34. The fuel element according to claim 28, wherein said thermally conductive layer deposited within said cladding tube is colloidal carbon.

35. The fuel element according to claim 34, wherein said thermally conductive layer deposited within said cladding tube is between about 3 and about 50 microns.

36. The fuel element according to claim 28, wherein said inner layer is a monolith layer.

37. The fuel element according to claim 36, wherein said inner monolith layer is formed by chemical vapor deposition.

38. The fuel element according to claim 28, wherein said crack propagation prevention layer is pyrolytic carbon.

39. The fuel element according to claim 38, wherein said crack propagation prevention layer formed of pyrolytic carbon is between about 10 and about 50 microns.

40. The fuel element according to claim 28, wherein said central layer is a composite of silicon carbide surrounded by a silicon carbide matrix.

41. The fuel element according to claim 40, wherein said central composite layer includes silicon carbide fibers.

42. The fuel element according to claim 41, wherein said silicon carbide fibers are in the form of a tow or a ribbon that includes between about 500 and about 1600 fibers having between about 8 and about 14 microns in diameter.

43. The fuel element according to claim 42, wherein said silicon carbide fibers include a carbon interface coating thickness of between about 0.1 and about 1 micron.

44. The fuel element according to claim 28, further including an outer monolith layer for reducing corrosion during reactor operation.

45. The fuel element according to claim 44, wherein said outer monolith layer is high density silicon carbide formed by a process selected from the group consisting of chemical vapor infiltration and chemical vapor deposition.

46. The fuel element according to claim 44, wherein said outer monolith layer has a thickness between about 3 and about 10 mils.

47. The fuel element according to claim 28, wherein said multilayer silicon carbide tube is substantially formed of stoichiometric beta silicon carbide crystals that are resistant to damage by neutron radiation.

48. The fuel element according to claim 28, further including hermetically sealed end caps.

49. The fuel element according to claim 48, wherein said end caps are formed of high density silicon carbide.

50. The fuel element according to claim 49, wherein said end caps are substantially formed of stoichiometric beta silicon carbide crystals that are resistant to damage by neutron radiation.

51. The fuel element according to claim 48, wherein said end caps are diffusion bonded to said multilayer silicon carbide tube.

52. The fuel element according to claim 28, wherein said multilayer silicon carbide tube is between about 1.5 and about 14 feet in length, with a tube wall thickness between about 20 and about 50 mils and with a tube outside diameter between about 0.25 and about 0.5 inches.
